(19) United States
(12) Patent Application Publication
(10) Pub. No.: US 2005/0193194 A1
(43) Pub. Date: Sep. 1, 2005

(54) Contents transmitting apparatus and method of transmitting contents

(76) Inventor: Takashi Kokubo, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/017,054

(22) Filed: Dec. 21, 2004

(30) Foreign Application Priority Data
Dec. 26, 2003 (JP) 2003-433274

(51) Int. Cl. H04L 9/00

(52) U.S. Cl. 713/160

(57) ABSTRACT

The present invention comprises an encrypting unit which encrypts input contents in a predetermined encryption mode, a header forming unit which forms a header portion including the encryption mode used for the encryption, and a transmitting unit which transmits a packet obtained by synthesizing the formed header portion and the encrypted contents. The header forming unit adds control information concerning number of receiving units to the encryption mode and adds the encryption mode to the header portion.

### CROSS-REFERENCE TO RELATED APPLICATIONS

This application is based upon and claims the benefit of priority from prior Japanese Patent Application No. 2003-433274, filed Dec. 26, 2003, the entire contents of which are incorporated herein by reference.

### BACKGROUND OF THE INVENTION

1. Field of the Invention

This invention relates to improvement of a contents transmitting apparatus and a method of transmitting contents, capable of encrypting contents and transmitting them to a transmission path.

2. Description of the Related Art

It is known that, recently, a network system allowing a plurality of AV devices to be connected in a free style can be constructed with a serial bus using a digital interface based on the IEEE (Institute of Electrical and Electronics Engineers) 1394 standards.

The IEEE 1394 serial bus is used especially for a digital broadcast receiving device such as an STB (Set Top Box) and a digital recording-reproducing device such as a D-VHS (Digital-Video Home System) device. A high-speed high-definition recording-reproducing system is thereby constructed.

In the network system using the IEEE 1394 serial bus, DTCP (Digital Transmission Content Protection) standards are defined to protect contents (digital synchronization type packet data) transmitted on the serial bus from falsification and illegal copying.

Under the DTCP standards, the contents transmitting device authenticates each of a plurality of receiving devices (Sink) connected to the serial bus. Every time authentication is succeeded, the number of authentication is incremented. If the number of authentication exceeds a determined number (32 or 62 in the current situation), further authentication is prohibited.

The transmitting device encrypts the contents and transmits the encrypted contents to the authenticated number (maximum of 32 or 62) of receiving devices such that the contents can be decrypted by the receiving devices. In this case, encrypting the contents according to the encryption mode is defined under the DTCP standards.

Incidentally, the number of receiving devices authenticated by the transmitting device, i.e. the number of receiving devices to which the contents can be distributed is limited under the DTCP standards. For this reason, for example, contents such as educational contents can hardly be distributed due to limitation of the number of receiving devices.

To solve this problem, inserting information representing whether the number of receiving devices authenticated by the transmitting device should be limited into the contents can be conceived. In this case, to prevent the information that the number of receiving devices should be limited, from being falsified by the information that the number of receiving devices does not need be limited, the information representing whether the number of receiving devices should be limited needs to be encrypted and then transmitted.

As for the receiving devices, however, some recording-reproducing devices that do not have the decrypting function, but merely record and reproduce the input digital data as encrypted exist. Since such recording-reproducing devices cannot decrypt the information representing whether the number of receiving devices should be limited, they cannot transmit the reproduced data.

PCT International publication No. 98/02881 discloses an invention that by inserting copy generation management information into the data converted into the data format of the network bus with a format corresponding to the data format of the network bus, the receiving side can also detect the copy generation management information while processing the data of the data format of the network bus.

However, PCT International publication No. 98/02881 does not have any descriptions about solving the problem resulting from embedding the information representing whether the number of receiving devices authenticated by the transmitting device should be limited, into the contents.

The present invention has been accomplished to solve the above-described problems. The object of the present invention is to provide a contents transmitting apparatus and a method of transmitting contents which allow the information representing whether the number of receiving devices should be limited to be recognized even if the receiving devices do not have the decrypting function and which can sufficiently protect the contents.

### BRIEF SUMMARY OF THE INVENTION

According to an aspect of the present invention, there is provided a contents transmitting apparatus comprising an input unit to which contents are input, an encrypting unit which encrypts the contents input to the input unit in a predetermined encryption mode, a header forming unit which forms a header portion including the encryption mode used for the encryption in the encrypting unit, and a transmitting unit which transmits a packet obtained by synthesizing the header portion formed by the header forming unit and the contents encrypted by the encrypting unit. The header forming unit adds control information concerning number of receiving units to the encryption mode and adds the encryption mode to the header portion.

According to another aspect of the present invention, there is provided a method of transmitting contents. The method comprises inputting contents, encrypting the input contents in a predetermined encryption mode, adding control information concerning number of receiving units to the encryption mode used in the encryption and forming a header portion including the control information and the encryption mode, and transmitting a packet obtained by synthesizing the formed header portion and the encrypted contents.

According to the above-explained invention, when a packet obtained by synthesizing the contents encrypted in the predetermined encryption mode and the header portion including the encryption mode used for the encryption is transmitted, the control information representing limitation/no limitation of the number of the receiving devices is added to the encryption mode and the encryption mode is added to the header portion. Therefore, the receiving devices can recognize the information representing whether the number of receiving devices should be limited even if they do not have a decrypting function. In addition, the contents can be sufficiently protected.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing a network system according to an embodiment of the present invention;

FIG. 2 is an illustration showing a PCP structure of transmitted contents in the embodiment;

FIG. 3 is a block diagram showing details of a transmitting device in the embodiment;

FIG. 4 is an illustration showing a packet format of PCP in the embodiment;

FIG. 5 is a table showing current encryption modes described in the PCP header portion in the packet format;

FIG. 6 is a table showing encryption modes described in the PCP header portion in the embodiment;

FIG. 7 is a block diagram showing an example of contents transmission according to the embodiment;

FIG. 8 is a flowchart showing operations of the transmitting device according to the embodiment;

FIG. 9 is an illustration showing a packet structure of transmitted packets according to a modified example of the embodiment;

FIG. 10 is a table showing current encryption modes described in a header portion of the packet structure shown in FIG. 9; and

FIG. 11 is a table showing encryption modes described in the header portion according to the modified example.

### DETAILED DESCRIPTION OF THE INVENTION

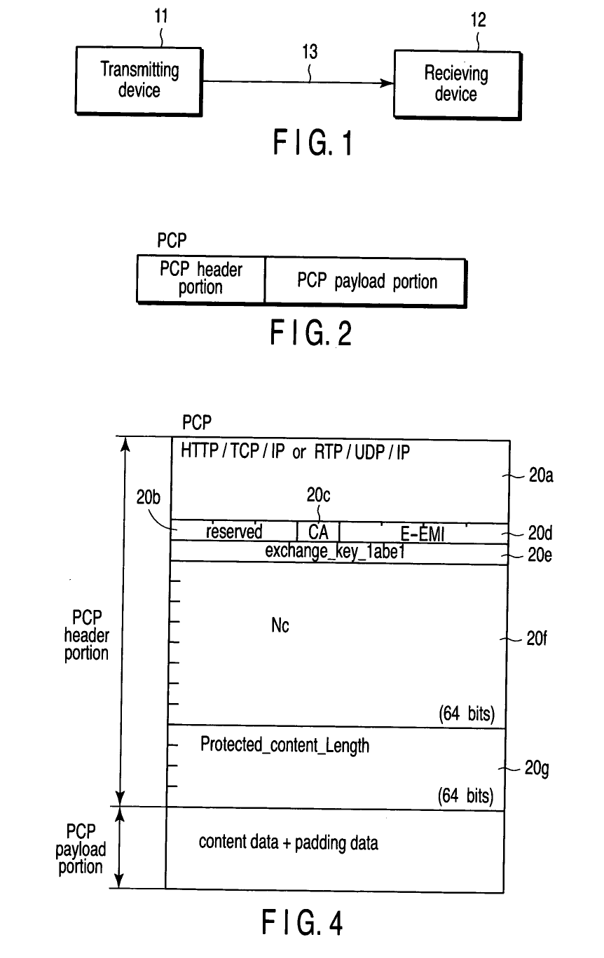

An embodiment of the present invention will be explained below with reference to the accompanying drawings. FIG. 1 is a schematic diagram showing a network system according to the embodiment of the present invention. In the network system, a transmitting device 11 and a receiving device 12 are connected via a serial bus 13. Contents are transmitted from the transmitting device 11 to the receiving device 12 by using a digital interface based on the IEEE 1394 standards.

In addition, DTCP standards mapped on an IP (Internet Protocol) are applied to the network system to protect contents transmitted on the serial bus 13 from falsification, illegal copying and the like. In other words, the transmitting device 11 and the receiving device 12 connected on the serial bus 13 are set to correspond to the DTCP standards.

Under the DTCP standards corresponding to the IP, contents are split by packet called PCP (Protected Content Packet) and then transmitted. The PCP includes a PCP header portion which is not encrypted, and an encrypted PCP payload portion.

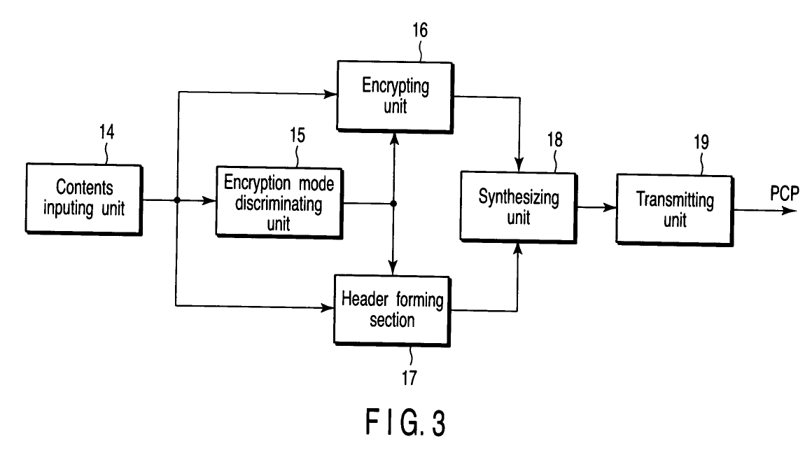

FIG. 3 shows details of the transmitting device 11. In the transmitting device 11, contents to be transmitted are input from a predetermined source (not shown) to a contents inputting unit 14. The contents which are input to the contents inputting unit 14 are supplied to an encryption mode discriminating unit 15, an encrypting unit 16 and a header forming unit 17.

The encryption mode discriminating unit 15 discriminates an encryption mode from the input contents and outputs the discriminated encryption mode to each of the encrypting unit 16 and the header forming unit 17. On the basis of the encryption mode input from the encryption mode discriminating unit 15, the encrypting unit 16 encrypts the input contents with a specific encryption key and forms data corresponding to the PCP payload portion shown in FIG. 2.

The header forming unit 17 includes the encryption mode which is input from the encryption mode discriminating unit 15 on the basis of the input contents, and forms data corresponding to the PCP header portion shown in FIG. 2. After that, the data output from the encrypting unit 16 and the data output from the header forming unit 17 are supplied to a synthesizing unit 18, which forms the PCP. The formed PCP is transmitted on the serial bus 13 via a transmitting unit 19.

FIG. 4 shows a packet format of the PCP formed as explained above. The PCP header portion has an area 20a where data representing a protocol such as HTTP/TCP/IP, RTP/UDP/IP or the like is described, a 3-bit reserved area 20b, an area 20c where 1-bit data representing the type CA of an encryption algorithm is described, an area 20d where 4-bit data representing encryption mode E-EMI is described, an area 20e where 8-bit data representing the number “exchange_key_label” of the encryption key which is currently used is described, an area 20f where 4-bit data representing a time-variable parameter Nc is described, and an area 20g where 32-bit data representing data length “Protected_content_Length” of the contents, which is not the data length after encryption, is described. In the PCP payload portion, 128-bit data “Content data+padding data” obtained by subjecting the encrypted contents to padding is described.

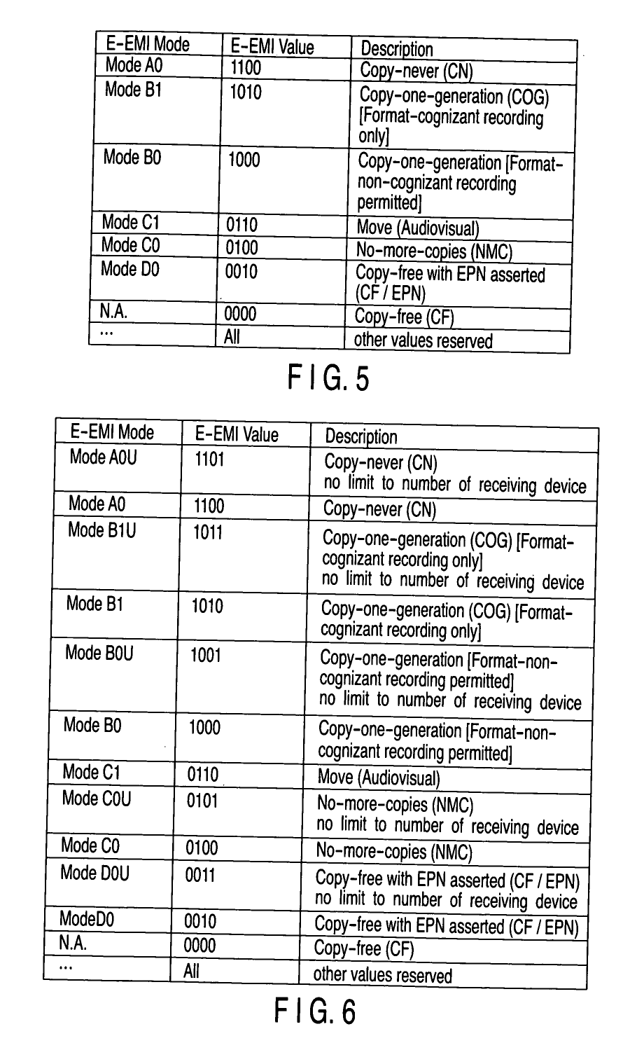

As for the encryption mode E-EMI, seven modes A0, B1, B0, C1, C0, D0 and N.A. representing “copy-never”, “copy-one-generation”, “copy-free” and the like for the data of the PCP payload portion are currently designated as shown in FIG. 5. The encryption mode E-EMI is a 4-bit mode, but currently is not substantially used when its LSB (bit at the right end of FIG. 5) remains “0”.

For this reason, in the present embodiment, five modes A0U, B1U, B0U, C0U and D0U can be set by setting the LSB of the 4-bit encryption mode E-EMI at “1”, in the above-explained modes other than mode C1, i.e. six modes A0, B1, B0, C0, D0 and N.A. as shown in FIG. 6.

In the modes A0U, B1U, B0U, C0U and D0U obtained by setting the LSB of the encryption mode E-EMI at “1”, the number of receiving devices 12 which can be authenticated is permitted to be unlimited while the condition set when the LSB of the encryption mode E-EMI is “0” is retained in relation to the copy control.

In other words, in seven modes A0, B1, B0, C1, C0, D0 and N.A. obtained by setting the LSB of the encryption mode E-EMI at “0”, the number of receiving devices 12 which can be authenticated by the transmitting device 11 is limited to up to 32 or 62 similarly to the current situation.

On the other hand, in five modes A0U, B1U, B0U, C0U and D0U obtained by setting the LSB of the encryption mode E-EMI at “1”, the number of receiving devices 12 which can be authenticated by the transmitting device 11 is unlimited.

In the transmitting device 11, the encrypting unit 16 encrypts the contents input to the contents inputting unit 14 on the basis of the encryption mode E-EMI discriminated by the encryption mode discriminating unit 15 and the header forming unit 17 describes the encryption mode E-EMI in the PCP header portion.

In addition, in the transmitting device 11, the contents input to the contents inputting unit 14 are subjected to copy limitation and it is discriminated whether the number of receiving devices 12 which can be authenticated is limited, on the basis of the encryption mode E-EMI.

According to the above-described embodiment, the information representing whether the number of receiving devices 12 which are authenticated by the transmitting device 11 should be limited is included in the encryption mode E-EMI described in the PCP header portion which is used to encrypt the contents but does not encrypt them when the PCP is transmitted.

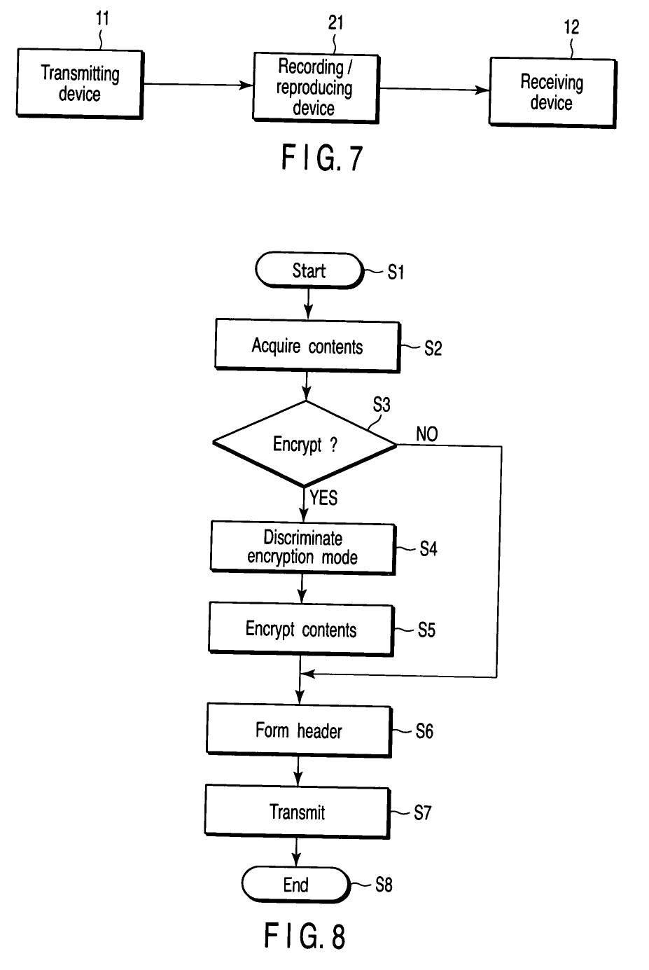

For this reason, for example, if the contents transmitted from the transmitting device 11 are temporarily stored in a recording/reproducing device 21 which does not have a decrypting function but has a function of recording and reproducing the input digital data as encrypted, and then transmitted from the recording/reproducing device 21 to the receiving devices 12, as shown in FIG. 7, the recording/reproducing device 21 can discriminate the contents of the encryption mode E-EMI described in the PCP header portion which is not encrypted, from the PCP transmitted from the transmitting device 11. It can be therefore easily recognized whether the number of receiving devices 12 to be authenticated is limited.

Since the encryption mode E-EMI is not encrypted, the information that the number of receiving devices 12 to be authenticated should be limited (i.e. the LSB of the encryption mode E-EMI is “0”) may be falsified to the information that the number of receiving devices 12 should not be limited (i.e. the LSB of the encryption mode E-EMI is “1”), during the transmission.

In this case, since the contents of the PCP payload portion is encrypted in the encryption mode E-EMI whose LSB is “0”, the contents cannot be decrypted in the encryption mode E-EMI having the falsified LSB of “1”. The contents can be therefore protected.

In the above-described embodiment, limiting or not limiting the number of receiving devices 12 to be authenticated by the transmitting device 11 is instructed in accordance with the LSB value of the encryption mode E-EMI. For example, however, if the contents of the 3-bit reserved area 20b in the PCP packet format shown in FIG. 4 is also included in the encryption mode, the number of receiving devices 12 to be authenticated by the transmitting device 11 can be limited in eight manners by using the 3-bit reserved area 20b.

In addition, in the above-described embodiment, the information representing whether the number of receiving devices 12 to be authenticated by the transmitting device 11 should be limited is added to the same copy control information, i.e. the information representing “copy-never”, “copy-one-generation”, “copy-free” and the like. In other words, limiting the number of receiving devices 12 to be authenticated by the transmitting device 11 and not limiting the number of authenticated receiving devices 12 are set in the copy control information of “copy-never”.

However, the invention is not limited to this, but limiting or not limiting the number of receiving devices 12 to be authenticated by the transmitting device 11 may be instructed on the basis of the contents of the copy control information. For example, the number of authenticated receiving devices 12 can be unlimited in accordance with the copy control information of “copy-never” or limited in accordance with the copy control information of “copy-one-generation” or “copy-free”.

FIG. 8 shows a flowchart of the operations of the transmitting device 11. When the processing is started (step S1), the transmitting device 11 acquires the contents from a predetermined source in step S2 and discriminates whether the contents should be encrypted in step S3.

If the transmitting device 11 discriminates that the contents should be encrypted (S3-YES), the transmitting device 11 discriminates the encryption mode E-EMI from the contents in step S4, and encrypts the contents on the basis of the discriminated encryption mode E-EMI to form the PCP payload portion in step S5.

After step S5, if the transmitting device 11 discriminates that the contents does not need to be encrypted (S3-NO) in step S3, the transmitting device 11 forms the PCP header portion in step S6, synthesizes the PCP header portion and the PCP payload portion and transmits the synthesized portions to the serial bus 13 in step S7 and ends the processing (step S8).

In the above-described embodiment, under the DTCP standards corresponding to the IP, the information representing whether the number of receiving devices 12 to be authenticated by the transmitting device 11 should be limited is included in the encryption mode E-EMI. However, the information can also be included under the DTCP standards that do not correspond to the IP.

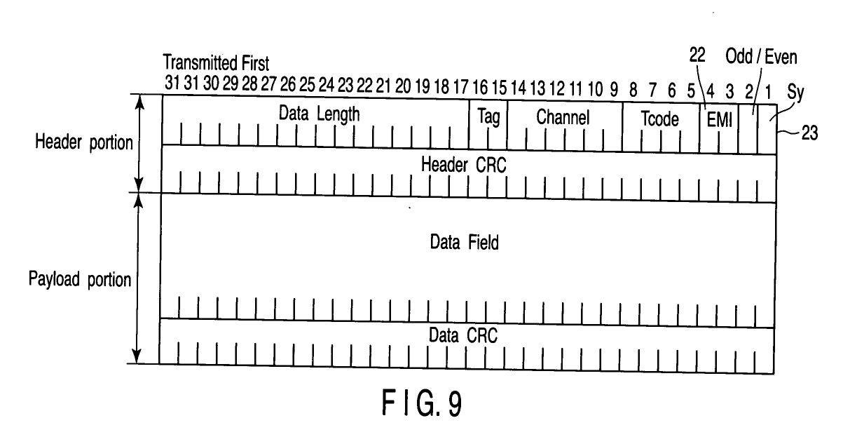

FIG. 9 shows a packet structure under the DTCP standards that do not correspond to the IP. A 2-bit area 22 where data representing the encryption mode EMI is described is provided in the header portion of the packet structure.

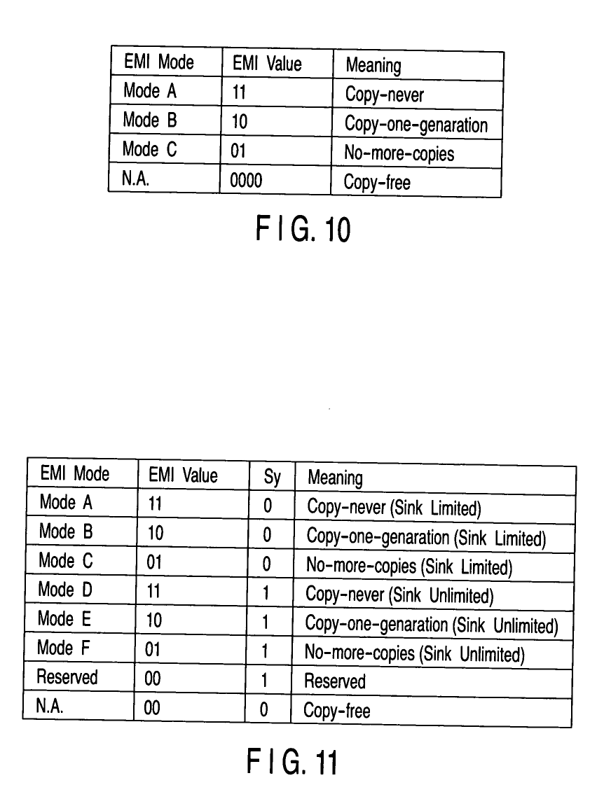

As for the encryption mode EMI, four modes A, B, C, and N.A. representing “copy-never”, “copy-one-generation”, “copy-free” and the like are currently designated for the data of the payload portion as shown in FIG. 10.

As shown in FIG. 9, a 1-bit Sy field area 23 exists in the header portion and is not currently used. For this reason, if the 1-bit Sy field data is included in the encryption mode, the data can represent whether the number of receiving devices 12 to be authenticated by the transmitting device 11 should be limited.

In other words, in four modes A, B, C and N.A. in which the Sy field is “0” as shown in FIG. 11, the number of receiving devices 12 to be authenticated by the transmitting device 11 is limited to up to 32 or 62. On the other hand, in three modes D, E and F in which the Sy field is “1”, the number of receiving devices 12 to be authenticated by the transmitting device 11 is unlimited.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

1. A contents transmitting apparatus comprising:
an input unit to which contents are input;
an encrypting unit which encrypts the contents input to the input unit in a predetermined encryption mode;
a header forming unit which forms a header portion including the encryption mode used for the encryption in the encrypting unit; and
a transmitting unit which transmits a packet obtained by synthesizing the header portion formed by the header forming unit and the contents encrypted by the encrypting unit,
wherein the header forming unit forms the header portion by adding control information concerning number of receiving units to the encryption mode.

2. The contents transmitting apparatus according to claim 1, wherein the header forming unit forms the header portion by adding the control information representing limitation/no limitation of the number of the receiving devices to the encryption mode.

3. The contents transmitting apparatus according to claim 1, wherein the header forming unit forms the header portion by adding the control information representing that the number of the receiving devices is unlimited to the encryption mode.

4. The contents transmitting apparatus according to claim 1, wherein the header forming unit forms the header portion by adding the control information representing the number of the receiving devices to the encryption mode.

5. The contents transmitting apparatus according to claim 2, wherein the encryption mode includes copy control information for the contents.

6. The contents transmitting apparatus according to claim 3, wherein the encryption mode includes copy control information for the contents.

7. The contents transmitting apparatus according to claim 4, wherein the encryption mode includes copy control information for the contents.

8. The contents transmitting apparatus according to claim 5, wherein contents of the copy control information correspond to contents of control based on the control information.

9. The contents transmitting apparatus according to claim 6, wherein contents of the copy control information correspond to contents of control based on the control information.

10. The contents transmitting apparatus according to claim 7, wherein contents of the copy control information correspond to contents of control based on the control information.

11. A method of transmitting contents, comprising:
inputting contents;
encrypting the input contents in a predetermined encryption mode;
forming a header portion including the encryption mode used in the encryption and a control information concerning number of receiving units by adding the control information to the encryption mode; and
transmitting a packet obtained by synthesizing the formed header portion and the encrypted contents.

12. The method according to claim 11, wherein the header portion is formed by adding the control information representing limitation/no limitation of the number of the receiving devices to the encryption mode.

13. The method according to claim 11, wherein the header portion is formed by adding the control information representing that the number of the receiving devices is unlimited to the encryption mode.

14. The method according to claim 11, wherein the header portion is formed by adding the control information representing the number of the receiving devices to the encryption mode.

15. The method according to claim 12, wherein the encryption mode includes copy control information for the contents.

16. The method according to claim 13, wherein the encryption mode includes copy control information for the contents.

17. The method according to claim 14, wherein the encryption mode includes copy control information for the contents.

18. The method according to claim 15, wherein contents of the copy control information correspond to contents of control based on the control information.

19. The method according to claim 16, wherein contents of the copy control information correspond to contents of control based on the control information.

20. The method according to claim 17, wherein contents of the copy control information correspond to contents of control based on the control information.
